(19) United States
(12) Patent Application Publication
(10) Pub. No.: US 2020/0057724 A1
(43) Pub. Date: Feb. 20, 2020

(54) CONTROLLER AND OPERATING METHOD THEREOF

(71) Applicant: SK hynix Inc., Gyeonggi-do (KR)

(72) Inventor: Eu-Joon BYUN, Gyeonggi-do (KR)

(21) Appl. No.: 16/351,802

(22) Filed: Mar. 13, 2019

(30) Foreign Application Priority Data
Aug. 14, 2018 (KR) 10-2018-0094950

(51) Int. Cl. G06F 12/10

(52) U.S. Cl. CPC G06F 12/10; G06F 2212/657; G06F 2212/1044

(57) ABSTRACT

A memory configured to store map data; a processor configured to compare a size of target map data corresponding to the un-map command with a threshold value; and an un-map manager configured to perform, when the size of target map data is equal to or greater than the threshold value, a vertical un-map operation on the target map data stored in the memory.

### CROSS-REFERENCE TO RELATED APPLICATION

The present application claims priority under 35 U.S.C. § 119(a) to Korean Patent Application No. 10-2018-0094950, filed on Aug. 14, 2018, the disclosure of which is incorporated herein by reference in its entirety.

### BACKGROUND

1. Field

Various embodiments of the present disclosure relate to a controller. Particularly, the embodiments relate to a controller capable of efficiently performing an un-map operation, and an operating method thereof.

### 2. Description of the Related Art

The computer environment paradigm has been transitioning to ubiquitous computing, which enables computing systems to be used anytime and anywhere. As a result, the demand for portable electronic devices, such as mobile phones, digital cameras, and laptop computers has increased rapidly. Those electronic devices generally include a memory system using a memory device as a data storage device. The data storage device may be used as a main memory or an auxiliary memory of a portable electronic device.

Since there is no mechanical driving part, a data storage device using a memory device provides advantages such as excellent stability and durability, high information access speed, and low power consumption. Also, such data storage device can have a quick data access rate with low power consumption compared to a hard disk device. Non-limiting examples of the data storage device having such advantages include universal serial bus (USB) memory devices, memory cards of diverse interfaces, solid state drives (SSDs), and the like.

### SUMMARY

Various embodiments of the present disclosure are directed to a memory system capable of efficiently processing map data.

In accordance with an embodiment of the present disclosure, a memory configured to store map data; a processor configured to compare a size of target map data corresponding to the un-map command with a threshold value; and an un-map manager configured to perform, when the size of target map data is equal to or greater than the threshold value, a vertical un-map operation on the target map data stored in the memory.

In accordance with an embodiment of the present disclosure, an operating method of a controller may include: storing map data into a memory; comparing a size of target map data corresponding to the un-map command with a threshold value; and performing, by an un-map manager, a vertical un-map operation on the target map data stored in the memory when the size of target map data is equal to or greater than the threshold value.

In accordance with an embodiment of the present disclosure, a memory system may include a memory device configured to store map data; a memory configured to buffering target map data; and a processor configured to perform, in response to an un-map command received from an external source along with logical addresses corresponding to the target map data, an un-map operation of changing one or more values of un-map bits in the target map data, and control the memory device to update the map data within the memory device according to the un-map operation, wherein the un-map bit of a piece of map data represents whether mapping relationship between logical and physical addresses within the piece of map data is valid, and wherein the changed value of the un-map bit represents the mapping relationship as invalid.

### BRIEF DESCRIPTION OF THE DRAWINGS

The description herein makes reference to the accompanying drawings wherein like reference numerals refer to like parts throughout the several views, and wherein:

FIG. 1 is a block diagram illustrating a data processing system including a memory system in accordance with an embodiment of the present disclosure;

FIG. 2 is a schematic diagram illustrating the memory in accordance with an embodiment of the present disclosure;

FIG. 3 is a schematic diagram illustrating a memory device of a memory system in accordance with an embodiment of the present disclosure;

FIG. 4 is a circuit diagram illustrating a memory cell array of a memory block in a memory device in accordance with an embodiment of the present disclosure;

FIG. 5 is a schematic diagram illustrating a three-dimensional structure of a memory device in accordance with an embodiment of the present disclosure;

FIG. 6A is a schematic diagram illustrating an un-map operation in accordance with an embodiment of the present disclosure;

FIG. 6B is a schematic diagram illustrating a normal un-map operation in accordance with an embodiment of the present disclosure;

FIG. 7 is a flowchart illustrating an un-map operation in accordance with an embodiment of the present disclosure; and

FIGS. 8 to 16 are schematic diagrams illustrating exemplary applications of a data processing system, in accordance with various embodiments of the present disclosure.

### DETAILED DESCRIPTION

Various embodiments of the disclosure are described below in more detail with reference to the accompanying drawings. However, elements and features of the present invention may be configured or arranged to form other embodiments, which may be modifications or variations of any of the disclosed embodiments. Thus, the present disclosure is not limited to the embodiments set forth herein. Rather, the described embodiments are provided so that this disclosure is thorough and complete and fully conveys the present invention to those skilled in the art to which this invention pertains. Throughout the disclosure, like reference numerals refer to like parts throughout the various figures and examples of the disclosure. It is noted that reference to “an embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance may be termed a second or third element in another instance without departing from the spirit and scope of the present disclosure.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Whether two elements are directly or indirectly connected/coupled, communication between the two elements may be wired or wireless, unless stated or the context indicates otherwise.

The terminology used herein is for the purpose of describing particular embodiments and is not intended to be limiting of the present disclosure.

As used herein, singular forms are intended to include the plural forms and vice versa, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and not be interpreted in an idealized or overly formal sense unless expressly so defined herein.

In the following description, numerous specific details are set forth in order to provide a thorough understanding of the present disclosure. Embodiments of the present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

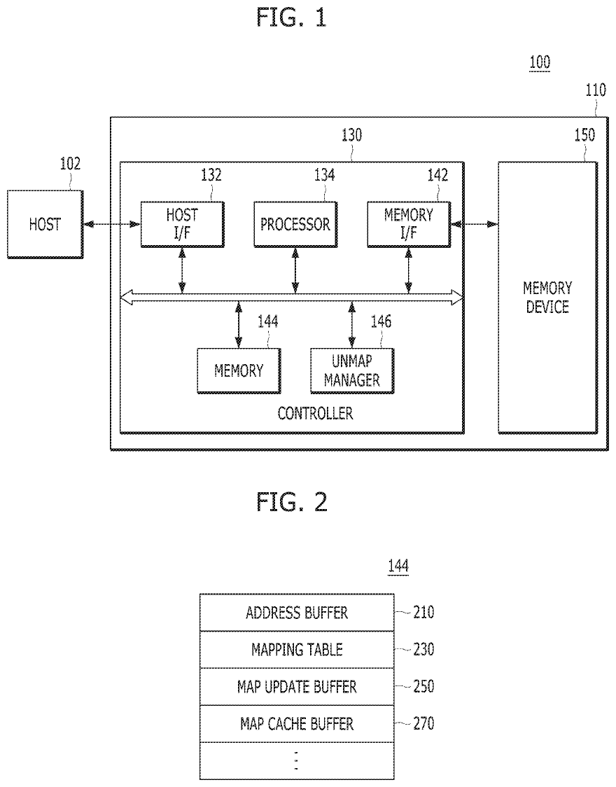

FIG. 1 is a block diagram illustrating a data processing system 100 in accordance with an embodiment of the present disclosure.

Referring to FIG. 1, the data processing system 100 may include a host 102 operatively coupled to a memory system 110.

The host 102 may include, for example, any of a variety of portable electronic devices such as a mobile phone, an MP3 player and a laptop computer or an electronic device such as a desktop computer, a game player, a television (TV), a projector, and the like.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device such as a dynamic random access memory (DRAM) and/or a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM), and/or a flash memory.

The memory system 110 may include a controller 130 and a memory device 150. The memory device 150 may store data to be accessed by the host 102, and the controller 130 may control storage of data in the memory device 150.

The controller 130 and the memory device 150 may be integrated into a single semiconductor device, which may be included in any of the various types of memory systems as exemplified above.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device that retains data stored therein even when electrical power is not supplied. The memory device 150 may store data provided from the host 102 through a write operation, and provide data stored therein to the host 102 through a read operation. The memory device 150 may include a plurality of memory blocks 152 to 156, each of which may include a plurality of pages. Each of the plurality of pages may include a plurality of memory cells to which a plurality of word lines (WL) are electrically coupled.

The controller 130 may control overall operations of the memory device 150, such as read, write, program and erase operations. For example, the controller 130 may control the memory device 150 in response to a request from the host 102. The controller 130 may provide the data, read from the memory device 150, to the host 102, and/or may store the data, provided by the host 102, into the memory device 150.

The controller 130 may include a host interface (I/F) 132, a processor 134, a memory interface (I/F) 142, a memory 144 and an un-map manager 146, all operatively coupled via an internal bus.

The host interface 132 may process commands and data provided from the host 102, and may communicate with the host 102 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (DATA), small computer system interface (SCSI), enhanced small disk interface (ESDI), and integrated drive electronics (IDE).

The memory interface 142 may serve as an interface for handling commands and data, transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134, when the memory device 150 is a flash memory and, in particular, a NAND flash memory.

The memory 144 may serve as a working memory of the memory system 110 and the controller 130, and may store temporary or transactional data for operating or driving the memory system 110 and the controller 130. The controller 130 may control the memory device 150 in response to a request from the host 102. The controller 130 may deliver data read from the memory device 150 into the host 102, may store data entered through the host 102 within the memory device 150. The memory 144 may be used to store data required for the controller 130 and the memory device 150 in order to perform these operations.

The memory 144 may be implemented with a volatile memory. The memory 144 may be implemented with a static random access memory (SRAM) or a dynamic random access memory (DRAM). Although FIG. 1 shows the memory 144 disposed within the controller 130, the disclosure is not limited thereto. That is, the memory 144 may be located within or externally to the controller 130. For instance, the memory 144 may be embodied by an external volatile memory having a memory interface transferring data and/or signals transferred between the memory 144 and the controller 130.

The memory 144 is described with reference to FIG. 2 in accordance with an embodiment of the present disclosure.

FIG. 2 is a schematic diagram illustrating the memory 144 in accordance with an embodiment of the present disclosure. FIG. 2 illustrates elements of the memory 144 for highlighting features of an embodiment of the present disclosure.

The memory 144 may include an address buffer 210, a mapping table 230, a map update buffer 250 and a map cache buffer 270.

The address buffer 210 may store map data. Map data may represent mapping relationship between a logical address LBA provided from the host 102 and a physical address PBA indicating a physical storage location of data within the memory device 150. Therefore, the address buffer 210 may store data representing mapping relationship between a logical address LBA and a physical address PBA.

Map data may include an un-map bit indicating whether corresponding map data is mapped or un-mapped. For example, when the un-map bit has a value of ‘1’, corresponding map data is mapped data. On the other hand, when the un-map bit has a value of ‘0’, corresponding map data is un-mapped data. Mapped data may indicate valid mapping relationship between a logical address LBA and a physical address PBA, and un-mapped data may indicate invalid mapping relationship between a logical address LBA and a physical address PBA.

The mapping table 230 may include a plurality of map segments. Each of the plurality of map segments may include plural pieces of map data. The mapping table 230 may include un-map information. The mapping table 230 may be updated when a change occurs in the un-map information.

The map update buffer 250 may temporarily store map data to be updated among plural pieces of map data stored in the memory device 150. For example, when a physical address PBA corresponding to a logical address LBA is changed, the map data may be updated. Or, when a change occurs in the un-map bit included in the map data, the map data may be updated. The updated map data may be stored to the memory device 150 by the processor 134. The mapping table 230 may also be updated to reflect the updated map data.

The map cache buffer 270 may cache map data corresponding to a logical address LBA of a recently provided read request or a frequently provided read request from the host 102. The cached map data may be compressed or non-compressed.

Referring back to FIG. 1, the processor 134 may control overall operations of the memory system 110. The processor 134 may control a program operation and a read operation of the memory device 150 in response to a program request and a read request provided from the host 102. The processor 134 may drive, in order to control overall operations of the memory system 110, firmware referred to as a flash translation layer (FTL). The processor 134 may be implemented with one or more of a microprocessor, a central processing unit (CPU) and the like.

An FTL may perform an operation as an interface between the host 102 and the memory device 150. The host 102 may transmit requests for write and read operations to the memory device 150 through the FTL.

The FTL may manage operations of address mapping, garbage collection, wear-leveling and the like. Particularly, the FTL may store map data. Therefore, the controller 130 may map a logical address, which is provided from the host 102, to a physical address of the memory device 150 through the map data. The memory device 150 may perform an operation like a general device because of the address mapping operation. Also, through the address mapping operation based on the map data, when the controller 130 updates data of a particular page, the controller 130 may program new data on another empty page and may invalidate old data of the particular page due to a characteristic of a flash memory device. Further, the controller 130 may store map data of the new data into the FTL.

When the host 102 may provide the un-map command with controller 130, e.g., in response to a user request, the map data may be un-mapped. That is, the mapping relationship between LBA and PBA corresponding to the map data may be broken.

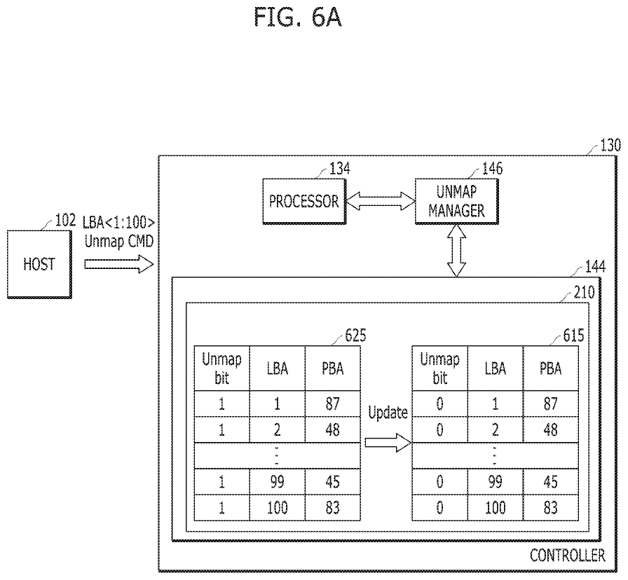

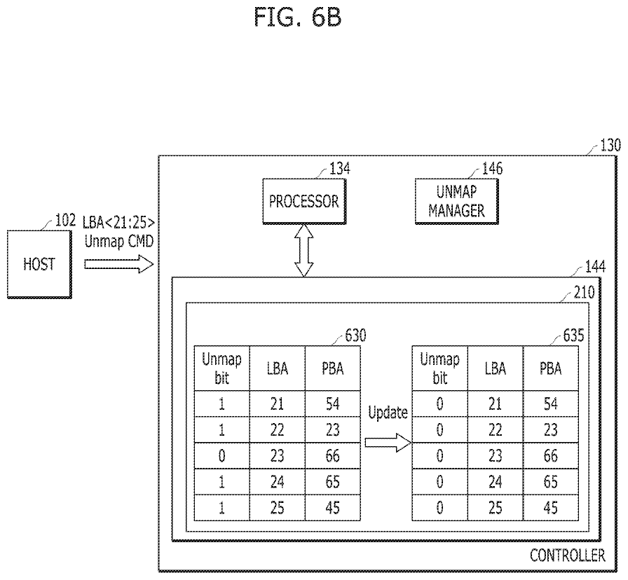

The un-map command may include location information indicating where the target map data corresponding to the un-map command is stored in the memory 144 and size information indicating a size of the target map data. The location information and the size information may be indicated by one or more logical addresses LBAs. The processor 134 may identify the location and the size of the target map data stored in the memory 144 through the provided logical addresses LBAs, which will be described with reference to FIGS. 6A and 6B. The processor 134 may compare the size of the target map data with a threshold, which may be predetermined.

When the size of the target map data is less than the threshold, the processor 134 may perform a normal un-map operation to the target map data. Specifically, the processor 134 may change the un-map bit for each piece of the target map data. For example, when the un-map bit has a value of ‘1’ for a corresponding piece of the mapped data, the processor 134 may change the value of the un-map bit to ‘0’ for each piece of the target map data. Also, the processor 134 may update the mapping table 230 in order to reflect the changed value of the un-map bit into the mapping table 230.

When the size of the target map data is equal to or greater than the threshold, the processor 134 may request the un-map manager 146 to perform a vertical un-map operation.

The un-map manager 146 may perform a vertical un-map operation of collectively changing values of the un-map bits included in the target map data in response to the request provided from the processor 134. Specifically, the processor 134 may provide the un-map manager 146 with location information indicating where the target map data corresponding to the un-map command is stored within the memory 144, size information of the target map data and an offset value of the un-map bit for each piece of the target map data. The un-map manager 146 may perform a vertical un-map operation to the target map data based on the information provided from the processor 134.

Specifically, the un-map manager 146 may identify, based on the provided location information of the target map data, a start point of the location where the target map data is stored within the memory 144. The un-map manager 146 may set a range of a vertical un-map operation based on the size information of the target map data. The un-map manager 146 may detect the un-map bit within a corresponding piece of the target map data based on the provided offset value of the un-map bit for the corresponding piece of the target map data. When all pieces of map data have the same data structure, the un-map bit included in each piece of the map data may have the same offset value. For example, when the un-map bit is the most significant bit within a piece of map data, the un-map bit may have the offset value of ‘1’. However, this configuration is merely an example; the present disclosure is not limited thereto.

Then, the un-map manager 146 may collectively change the values of the un-map bits included in the target map data. For example, when the un-map bit has a value of ‘1’ for a corresponding piece of the target map data, the processor 134 may collectively change the values of the un-map bits to ‘0’ for the target map data. Also, the un-map manager 146 may update the mapping table 230 in order to reflect the changed values of the un-map bits into the mapping table 230.

Although not shown in the FIG. 1, the controller 130 may further include an error correction code (ECC) component, a power manager (PMU).

The ECC component may detect and correct errors in the data read from the memory device 150 during the read operation. When the number of the error bits is greater than or equal to a threshold number of correctable error bits, the ECC component may not correct error bits but instead may output an error correction fail signal indicating failure in correcting the error bits.

The ECC component may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and the like. The ECC component may include all or some of circuits, modules, systems or devices for performing the error correction operation based on at least one of the above described codes.

The PMU may provide and manage power of the controller 130.

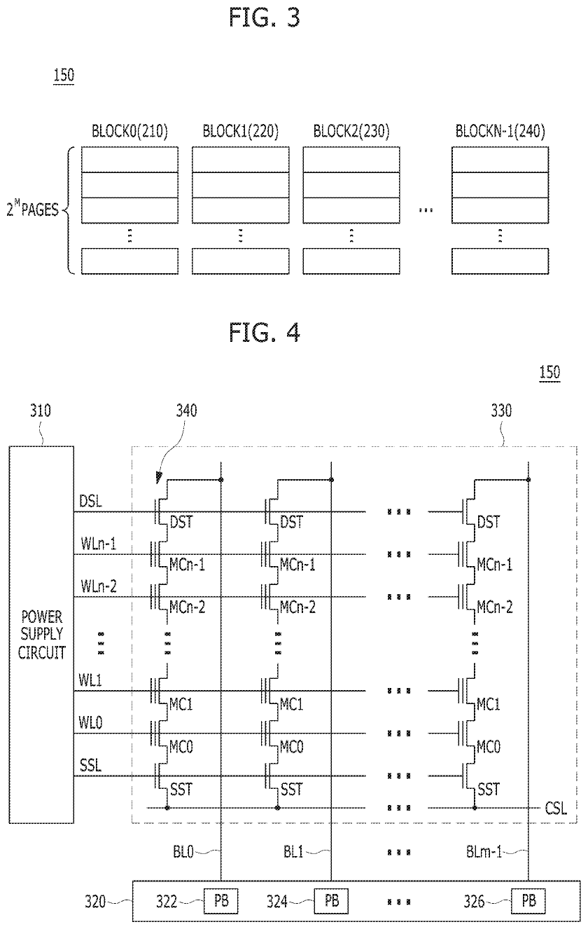

The memory device 150 is described with reference to FIGS. 3 to 5 in accordance with an embodiment of the present disclosure.

FIG. 3 is a schematic diagram illustrating a memory device, e.g., the memory device 150 of FIG. 1, in accordance with an embodiment of the present disclosure.

Referring to FIG. 3, the memory device 150 may include the plurality of memory blocks BLOCK( ) to BLOCKN−1, and each of the blocks BLOCK( ) to BLOCKN−1 may include a plurality of pages, for example, 2^{M} pages, the number of which may vary according to circuit design. The memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

FIG. 4 is a circuit diagram illustrating a memory block 330 in the memory device 150 in accordance with an embodiment of the present disclosure.

Referring to FIG. 4, the memory block 330 may correspond to any of the plurality of memory blocks 152 to 156 in the memory device 150 of the memory system 110.

The memory block 330 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be electrically coupled in series between the select transistors DST and SST. The respective memory cells MC0 to MCn−1 may be configured as single level cells (SLC) each of which may store 1 bit of information, or as multi-level cells (MLC) each of which may store a plurality of bits. The strings 340 may be electrically coupled to the corresponding bit lines BL0 to BLm−1, respectively. For reference, in FIG. 4, ‘DSL’ denotes a drain select line, ‘SSL’ denotes a source select line, and ‘CSL’ denotes a common source line.

While FIG. 4 only shows, as an example, that the memory block 330 is constituted with NAND flash memory cells, it is to be noted that the memory block 330 of the memory device 150 is not limited to a NAND flash memory. The memory block 330 may be realized by a NOR flash memory, a hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A power supply circuit 310 of the memory device 150 may supply word line voltages, for example, a program voltage, a read voltage and a pass voltage, to respective word lines according to an operation mode, as well as supply voltages to bulks, for example, well regions in which the memory cells are formed. The power supply circuit 310 may perform a voltage generating operation under the control of a control circuit (not shown). The power supply circuit 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read and write (read/write) circuit 320 of the memory device 150 may be controlled by the control circuit, and may serve as a sense amplifier or a write driver according to an operation mode. During a verification operation or a normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

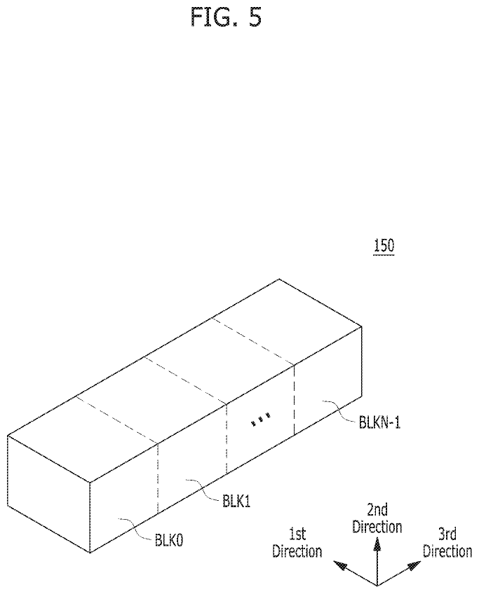

FIG. 5 is a schematic diagram illustrating a three-dimensional (3D) structure of a memory device, e.g., the memory device 150, in accordance with an embodiment of the present disclosure.

Specifically, as illustrated in FIG. 5, the memory device 150 may be embodied in a nonvolatile memory device having a 3D stack structure. When the memory device 150 has a 3D structure, the memory device 150 may include a plurality of memory blocks BLK0 to BLKN−1 each having a 3D structure (or a vertical structure). As an alternative to the 3D structure shown in FIG. 4, the memory device 150 may be configured as a two-dimensional (2D) structure.

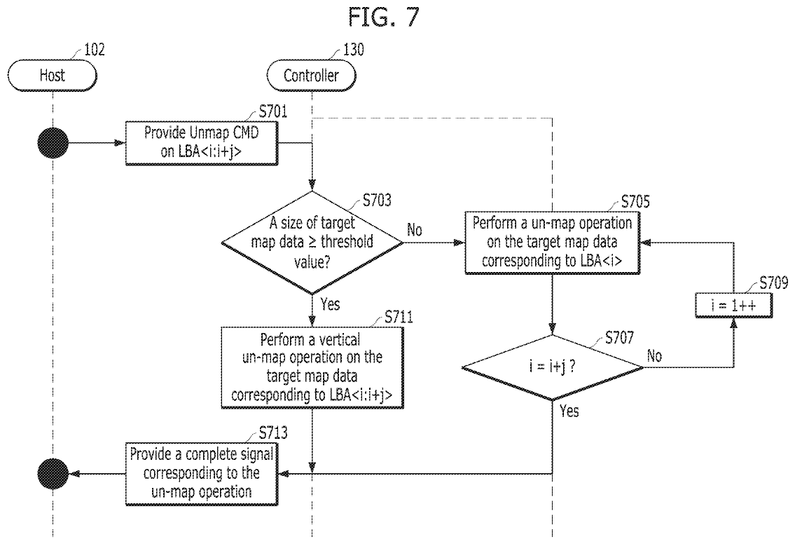

An un-map operation is described with reference to FIGS. 6A to 7 in accordance with an embodiment of the present disclosure.

FIG. 6A is a schematic diagram illustrating an un-map operation in accordance with an embodiment of the present disclosure. It is assumed, for the purpose of the present description, that a size of target map data indicated by a logical address LBA provided from the host 102 is equal to or greater than a threshold value. Also, it is assumed that the un-map bit of each piece of target map data is the most significant bit of the target map data, the un-map bit has a value of ‘1’ for a corresponding piece of mapped data and has a value of ‘0’ for a corresponding piece of un-mapped data.

The host 102 may remove data from a file system included therein, e.g., in response to a user request. The host 102 may provide the memory system 110 with an un-map command for un-mapping target map data 625 corresponding to data stored in the memory device 150 and corresponding to the removed data of the file system. The target map data 625 may be indicated by logical addresses LBAs provided along with the un-map command. For example, as illustrated in FIG. 6A, the host 102 may provide the memory system 110 with an un-map command for un-mapping target map data 625 represented by first to 100th logical addresses LBA<1:100>.

In response to the un-map command, the processor 134 may compare the size of the target map data 625 with the threshold value. The size of the target map data 625 may be indicated by the first to 100^{th} logical addresses LBA<1:100>. Since the size of the target map data 625 is equal to or greater than the threshold value as assumed above, the processor 134 may request the un-map manager 146 to perform an un-map operation to the target map data 625.

The un-map manager 146 may identify the location of the target map data 625 stored in the address buffer 210. The location of the target map data 625 within the memory 144 may be indicated by the first to 100th logical addresses LBA<1:100>. The un-map manager 146 may determine the target map data 625 corresponding to the first to 100th logical addresses LBA<1:100> as a target of an un-map operation. The un-map manager 146 may identify the most significant bit of each piece of the target map data 625 as the un-map bit of the piece of the target map data 625.

The un-map manager 146 may collectively change the values of the un-map bits included in the target map data 625 into ‘0’ such that the target map data 625 is updated to changed target map data 615. Also, the un-map manager 146 may update the mapping table 230 in order to reflect the changed target map data 615 into the mapping table 230.

While the un-map manager 146 performs the vertical un-map operation in response to the un-map command, the processor 134 may process another command. That is, the processor 134 may reduce time required to process the un-map command.

FIG. 6B is a schematic diagram illustrating a normal un-map operation in accordance with an embodiment of the present disclosure. It is assumed, for the purpose of this description, that a size of target map data indicated by logical addresses LBAs provided from the host 102 is less than a threshold value. Also, it is assumed that the un-map bit of each piece of a target map data is the most significant bit of the target map data, the un-map bit has a value of ‘1’ for a corresponding piece of mapped data and has a value of ‘0’ for a corresponding piece of un-mapped data.

As illustrated in FIG. 6B, the host 102 may remove data from a file system therein. The host 102 may provide the memory system 110 with an un-map command for un-mapping target map data 630 corresponding to data stored in the memory device 150 and corresponding to the removed data of the file system. The target map data 630 may be indicated by logical addresses LBAs provided along with the un-map command. For example, as illustrated in FIG. 6B, the host 102 may provide the memory system 110 with an un-map command for un-mapping target map data 630 indicated by 21^{st} to 25^{th} logical addresses LBA<21:25>.

In response to the un-map command, the processor 134 may compare the size of the target map data 630 with the threshold value. The size of the target map data 625 may be indicated by the 21^{st} to 25^{th} logical addresses LBA<21:25>. Since the size of the target map data 630 is less than the threshold value as assumed above, the processor 134 may perform an un-map operation to the target map data 630 by itself.

The processor 134 may identify the location of the target map data 630 stored in the address buffer 210. The location of the target map data 630 within the memory 144 may be indicated by the 21^{st} to 25^{th} logical addresses LBA<21:25>. The processor 134 may determine the target map data 630 corresponding to the 21^{st} to 25th logical addresses LBA<21:25> as a target of an un-map operation. The processor 134 may identify the most significant bit of each piece of the target map data 630 as the un-map bit of the piece of the target map data 630.

The processor 134 may collectively change the values of the un-map bits included in the target map data 630 into ‘0’ such that the target map data 630 is updated to become changed target map data 635. Also, the processor 134 may update the mapping table 230 in order to reflect the changed target map data 635 into the mapping table 230.

FIG. 7 is a flowchart illustrating an un-map operation in accordance with an embodiment of the present disclosure.

At step S701, the host 102 may provide the memory system 110 with an un-map command for un-mapping a target map data corresponding to data stored in the memory device 150 and corresponding to data removed from a file system included in the host 102. The target map data may be indicated by logical addresses LBA<i:i+j> provided along with the un-map command.

At step S703, the processor 134 may compare the size of the target map data indicated by the logical addresses LBA<i:i+j> with the threshold value.

When the size of the target map data is less than the threshold value (“No” at step S703), the processor 134 may perform a normal un-map operation on the target map data by itself. Specifically, at step S705, the processor 134 may perform an un-map operation on a piece of the target map data corresponding to the i-th logical address LBA<i>.

At step S707, the processor 134 may determine whether the index ° i′ is equal to the index ‘i+j’. That is, the processor 134 may determine whether the current piece of target map data corresponding to the index T satisfies the range for the un-map command.

When the index ‘i’ is not equal to the index ‘i+j’ (“No” at step S707), the processor 134 may increase the index by an amount of ‘1’ at step S709. Then the processor 134 may repeat steps S705 to S709 until the current piece of target map data corresponding to the index ‘i’ satisfies the range for the un-map command.

When the index is equal to the index (“Yes” at step S707), the processor 134 may end the un-map operation and may provide the host 102 with the result of the un-map operation.

When the size of the target map data is equal to or greater than the threshold value (“Yes” at step S703), the un-map manager 146 may perform a vertical un-map operation to the target map data in response to a request provided from the processor 134. Specifically, at step S713, the un-map manager 146 may perform an un-map operation to the plural pieces of the target map data respectively indicated by the logical addresses LBA<i:i+j>.

As described above, when the size of the target map data is equal to or greater than the threshold value, the controller 130 including the un-map manager 146 as a separate element configured to perform the un-map operation may process the un-map command more rapidly, and may process another command (e.g., a read command or a write command) while processing the un-map command. Therefore, overall system performance may be improved.

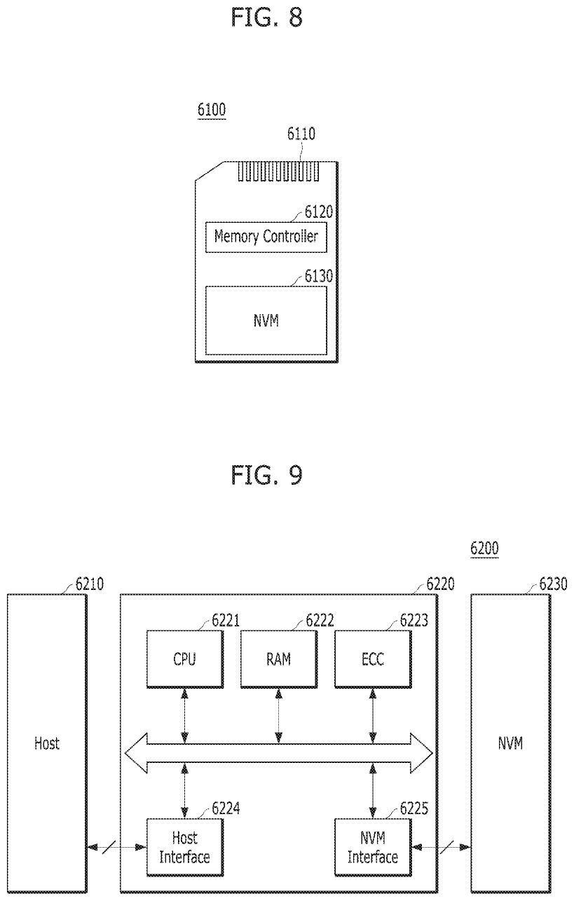

A data processing system and electronic devices which may be constituted with the memory system 110 including the memory device 150 and the controller 130, which are described above by referring to FIGS. 1 to 7, are described in detail below with reference to FIGS. 8 to 16.

FIGS. 8 to 16 are diagrams schematically illustrating exemplary applications of the data processing system of FIGS. 1 to 7 according to various embodiments.

FIG. 8 is a diagram schematically illustrating an example of the data processing system including the memory system in accordance with an embodiment. FIG. 8 schematically illustrates a memory card system 6100 to which the memory system may be applied.

Referring to FIG. 8, the memory card system 6100 may include a memory controller 6120, a memory device 6130 and a connector 6110.

More specifically, the memory controller 6120 may be connected to the memory device 6130, and may be configured to access the memory device 6130. The memory device 6130 may be embodied by a nonvolatile memory (NVM). By way of example but not limitation, the memory controller 6120 may be configured to control read, write, erase and background operations on the memory device 6130. The memory controller 6120 may be configured to provide an interface between the memory device 6130 and a host (not shown) and/or drive firmware for controlling the memory device 6130. That is, the memory controller 6120 may correspond to the controller 130 in the memory system 110 described with reference to FIGS. 1 to 7, while the memory device 6130 may correspond to the memory device 150 described with reference to FIGS. 1 to 7.

Thus, as shown in FIG. 1, the memory controller 6120 may include a random access memory (RAM), a processor, a host interface, a memory interface and an error correction component. The memory controller 130 may further include the elements described in FIG. 1.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi), and Bluetooth. Thus, the memory system and the data processing system may be applied to wired and/or wireless electronic devices, particularly mobile electronic devices.

The memory device 6130 may be implemented by a nonvolatile memory. For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may be so integrated to form a solid state drive (SSD). Also, the memory controller 6120 and the memory device 6130 may be so integrated to form a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), a secured digital (SD) card (e.g., SD, miniSD, microSD and SDHC), and/or a universal flash storage (UFS).

FIG. 9 is a diagram schematically illustrating another example of a data processing system 6200, including a memory system, in accordance with an embodiment.

Referring to FIG. 9, the data processing system 6200 may include a memory device 6230 having one or more nonvolatile memories (NVMs) and a memory controller 6220 for controlling the memory device 6230. The data processing system 6200 may serve as a storage medium such as a memory card (e.g., CF, SD, micro-SD or the like) or USB device, as described with reference to FIG. 1. The memory device 6230 may correspond to the memory device 150 in the memory system 110 described in FIGS. 1 to 7, and the memory controller 6220 may correspond to the controller 130 in the memory system 110 described in FIGS. 1 to 7.

The memory controller 6220 may control a read, write, or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC component of the controller 130. As described with reference to FIG. 1, the ECC circuit 6223 may generate an error correction code (ECC) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. In this case, the ECC circuit 6223 may correct an error using the parity bit. For example, as described with reference to FIG. 1, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may transmit to, and/or receive from, the host 6210 data or signals through the host interface 6224, and may transmit to, and/or receive from, the memory device 6230 data or signals through the NVM interface 6225. The host interface 6224 may be connected to the host 6210 through a parallel advanced technology attachment (DATA) bus, a serial advanced technology attachment (SATA) bus, a small computer system interface (SCSI), a universal serial bus (USB), a peripheral component interconnect-express (PCIe), or a NAND interface. The memory controller 6220 may have a wireless communication function with a mobile communication protocol such as wireless fidelity (WiFi) or Long Term Evolution (LTE). The memory controller 6220 may be connected to an external device, e.g., the host 6210, or another external device, and then transmit and/or receive data to and/or from the external device. As the memory controller 6220 is configured to communicate with the external device through one or more of various communication protocols, the memory system and the data processing system may be applied to wired and/or wireless electronic devices, particularly a mobile electronic device.

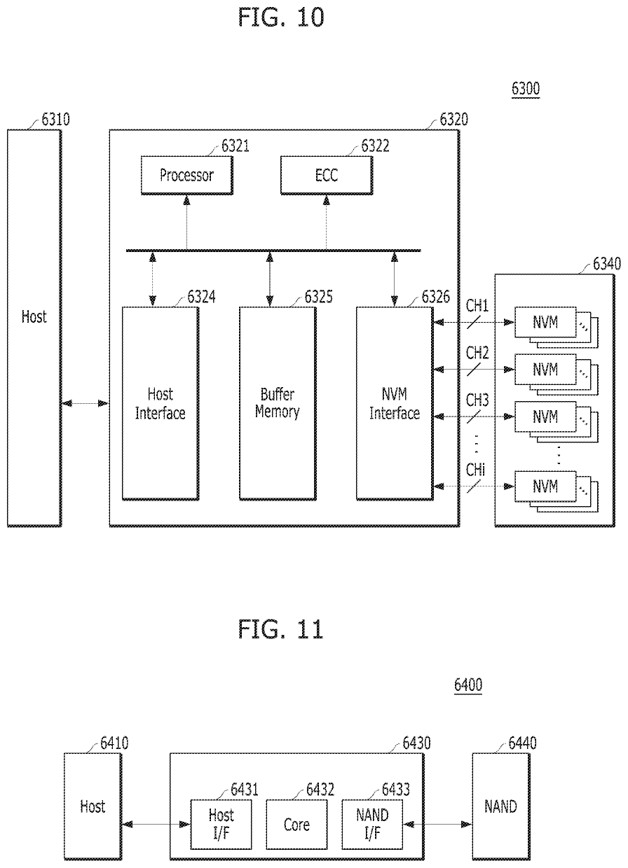

FIG. 10 is a diagram schematically illustrating another example of the data processing system including the memory system in accordance with an embodiment. FIG. 10 schematically illustrates a solid state drive (SSD) 6300 to which the memory system may be applied.

Referring to FIG. 10, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by any of various volatile memories such as a dynamic random access memory (DRAM), a synchronous DRAM (SDRAM), a double data rate (DDR) SDRAM, a low power DDR (LPDDR) SDRAM and a graphics RAM (GRAM) or nonvolatile memories such as a ferroelectric RAM (FRAM), a resistive RAM (RRAM or ReRAM), a spin-transfer torque magnetic RAM (STT-MRAM) and a phase-change RAM (PRAM). For the purpose of description, FIG. 10 illustrates that the buffer memory 6325 is disposed in the controller 6320, but the buffer memory 6325 may be external to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, i.e., RAID level information of the write command provided from the host 6310 in the SSDs 6300, and may output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 11 is a diagram schematically illustrating another example of the data processing system including the memory system in accordance with an embodiment. FIG. 11 schematically illustrates an embedded Multi-Media Card (eMMC) 6400 to which the memory system may be applied.

Referring to FIG. 11, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control the operations of the eMMC 6400, the host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I or UHS-II interface.

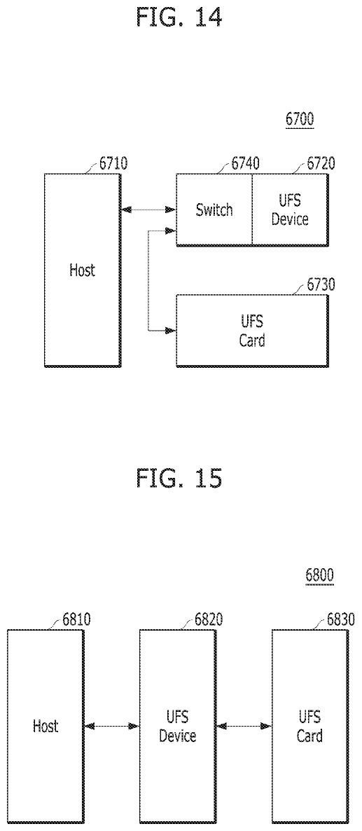

FIGS. 14 to 17 are diagrams schematically illustrating other examples of the data processing system including the memory system in accordance with embodiments. FIGS. 14 to 17 schematically illustrate universal flash storage (UFS) systems to which the memory system may be applied.

Referring to FIGS. 14 to 17, the UFS systems 6500, 6600, 6700 and 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired and/or wireless electronic devices or particularly mobile electronic devices, the UFS devices 6520, 6620, 6720, 6820 may serve as embedded UFS devices. The UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700 and 6800 may communicate with external devices, e.g., wired and/or wireless electronic devices or particularly mobile electronic devices through UFS protocols. The UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 11 to 13, and the UFS cards 6530, 6630, 6730, 6830 may be embodied in the form of the memory card system 6100 described with reference to FIG. 8.

Furthermore, in the UFS systems 6500, 6600, 6700 and 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, e.g., universal storage bus (USB) Flash Drives (UFDs), multi-media card (MMC), secure digital (SD), mini-SD, and micro-SD.

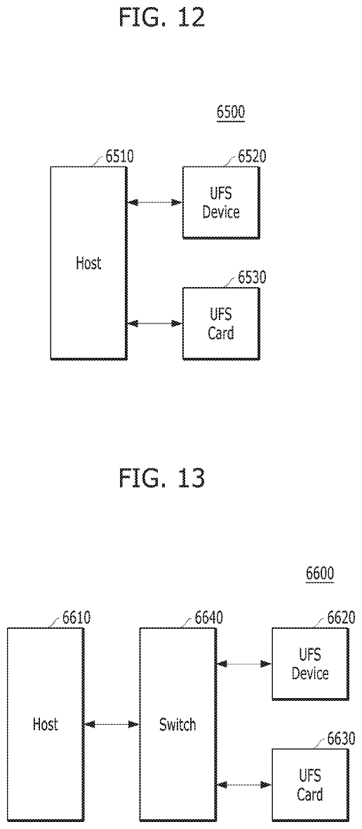

In the UFS system 6500 illustrated in FIG. 12, each of the host 6510, the UFS device 6520 and the UFS card 6530 may include UniPro. The host 6510 may perform a switching operation to communicate with at least one of the UFS device 6520 and the UFS card 6530. The host 6510 may communicate with the UFS device 6520 or the UFS card 6530 through link layer switching, e.g., L3 switching at the UniPro. In this case, the UFS device 6520 and the UFS card 6530 may communicate with each other through a link layer switching at the UniPro of the host 6510. FIG. 12 illustrates, as an example, the configuration in which one UFS device 6520 and one UFS card 6530 are connected to the host 6510. However, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520. Herein, the form of a star means an arrangement that a single device is coupled with plural other devices or cards for centralized control.

In the UFS system 6600 illustrated in FIG. 13, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. FIG. 13 illustrates as an example, the configuration in which one UFS device 6620 and one UFS card 6630 are connected to the switching module 6640. However, a plurality of UFS devices and UFS cards may be connected in parallel or in the form of a star to the switching module 6640, and a plurality of UFS cards may be connected in series or in the form of a chain to the UFS device 6620.

In the UFS system 6700 illustrated in FIG. 14, each of the host 6710, the UFS device 6720 and the UFS card 6730 may include UniPro. The host 6710 may communicate with the UFS device 6720 or the UFS card 6730 through a switching module 6740 performing a switching operation, for example, the switching module 6740 which performs link layer switching at the UniPro, for example, L3 switching. In this case, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. FIG. 14 illustrates as an example, the configuration in which one UFS device 6720 and one UFS card 6730 are connected to the switching module 6740. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 15, each of the host 6810, the UFS device 6820 and the UFS card 6830 may include M-PHY and UniPro. The UFS device 6820 may perform a switching operation to communicate with the host 6810 and the UFS card 6830. The UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. Here, the host 6810 and the UFS card 6830 may communicate with each other through target ID switching between the M-PHY and UniPro modules of the UFS device 6820. FIG. 15 illustrates an embodiment in which one UFS device 6820 is connected to the host 6810 and one UFS card 6830 is connected to the UFS device 6820. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

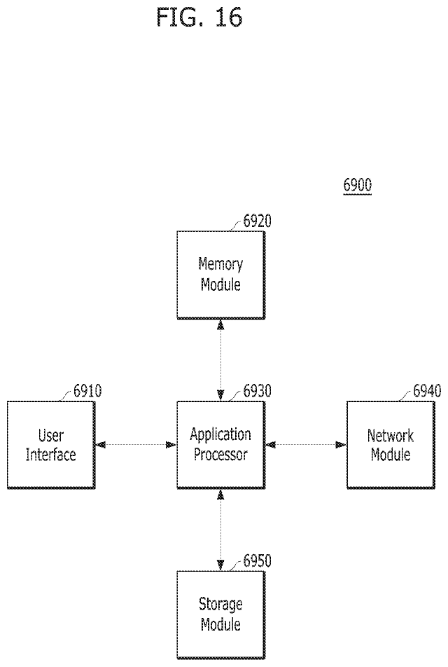

FIG. 16 is a diagram schematically illustrating another example of the data processing system including the memory system in accordance with an embodiment. FIG. 16 is a diagram schematically illustrating a user system 6900 to which the memory system may be applied.

Referring to FIG. 16, the user system 6900 may include a user interface 6910, a memory module 6920, an application processor 6930, a network module 6940, and a storage module 6950.

More specifically, the application processor 6930 may drive components included in the user system 6900, for example, an operating system (OS), and include controllers, interfaces and a graphic engine which control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, LPDDR SDARM, LPDDR3 SDRAM or LPDDR3 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but may also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices, particularly mobile electronic devices. Therefore, the memory system and the data processing system can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 12 to 17.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control the operations of the mobile electronic device, and the network module 6940 may serve as a communication module for controlling wired and/or wireless communication with an external device. The user interface 6910 may display data processed by the processor 6930 on a display and touch module of the mobile electronic device, or support a function of receiving data from the touch panel.

While aspects of the present invention has been illustrated and described with respect to specific embodiments, it will be apparent to those skilled in the art in light of the present disclosure that various changes and modifications may be made without departing from the spirit and scope of the invention as determined in the following claims,

What is claimed is:

1. A controller for processing an un-map command, the controller comprising:
a memory configured to store map data;
a processor configured to compare a size of target map data corresponding to the un-map command with a threshold value; and
an un-map manager configured to perform, when the size of target map data is equal to or greater than the threshold value, a vertical un-map operation on the target map data stored in the memory.

2. The controller of claim 1, wherein the un-map manager performs the vertical un-map operation based on location information indicating location where the target map data is stored in the memory, the size of the target map data, an offset value of an un-map bit.

3. The controller of claim 2, wherein the processor provides the un-map manager with the location information, the size of the target map data, the offset value of the un-map bit.

4. The controller of claim 3, wherein the processor processes another command while the un-map manager is performing the vertical un-map operation.

5. The controller of claim 1, wherein the un-map bit is set to have a first value for a corresponding piece of mapped data and have a second value for a corresponding piece of un-mapped data, among the map data stored in the memory.

6. The controller of claim 1, wherein the processor performs, when the size of target map data is less than the threshold value, a normal un-map operation to the target map data.

7. The controller of claim 6, wherein the memory stores a mapping table having the map data recorded.

8. The controller of claim 7, wherein the mapping table includes un-map information representing the un-map bit.

9. The controller of claim 8, wherein the un-map manager updates, during the vertical un-map operation, the un-map information recorded in the mapping table.

10. The controller of claim 8, wherein the processor updates, during the normal un-map operation, the un-map information recorded in the mapping table.

11. A method of a controller for processing an un-map command, the method comprising:
storing map data into a memory;
comparing a size of target map data corresponding to the un-map command with a threshold value; and
performing, by an un-map manager, a vertical un-map operation on the target map data stored in the memory when the size of target map data is equal to or greater than the threshold value.

12. The method of claim 11, wherein the vertical un-map operation includes performing the vertical un-map operation based on location information indicating location where the target map data is stored in the memory, the size of the target map data, an offset value of an un-map bit.

13. The method of claim 12, further comprising providing the un-map manager with the location information, the size of the target map data, the offset value of the un-map bit.

14. The method of claim 13, further comprising processing another command while the vertical un-map operation is being performed.

15. The method of claim 11, wherein the un-map bit is set to have a first value for a corresponding piece of mapped data and have a second value for a corresponding piece of un-mapped data, among the map data stored in the memory.

16. The method of claim 11, further comprising performing by a processor, when the size of target map data is less than the threshold value, a normal un-map operation to the target map data.

17. The method of claim 16, further comprising storing a mapping table having the map data recorded into the memory.

18. The method of claim 17, wherein the mapping table includes un-map information representing the un-map bit.

19. The method of claim 18, further comprising updating, during the vertical un-map operation, the un-map information recorded in the mapping table.

20. A memory system comprising:
a memory device configured to store map data;
a memory configured to buffering target map data; and
a processor configured to perform, in response to an un-map command received from an external source along with logical addresses corresponding to the target map data, an un-map operation of changing one or more values of un-map bits in the target map data, and control the memory device to update the map data within the memory device according to the un-map operation,
wherein the un-map bit of a piece of map data represents whether mapping relationship between logical and physical addresses within the piece of map data is valid, and
wherein the changed value of the un-map bit represents the mapping relationship as invalid.
